(19) United States
(12) Patent Application Publication
(10) Pub. No.: US 2026/0269969 A1
(43) Pub. Date: Sep. 10, 2026

(54) METHOD AND APPARATUS FOR CROSS-LINK-INTERFERENCE MITIGATION IN MOBILE COMMUNICATIONS

(71) Applicant: MediaTek Singapore Pte. Ltd., Singapore (SG)

(72) Inventor: Jozsef Gabor NEMETH, Cambridge (GB)

(21) Appl. No.: 19/163,575

(22) PCT Filed: Mar. 14, 2024
(86) PCT No.: PCT/CN2024/081612

§ 371 Date: Sep. 9, 2025

Related U.S. Application Data
(60) Provisional application No. 63/490,310, filed on Mar. 15, 2023.

(51) Int. Cl. H04J 11/00; H04L 25/02

(52) U.S. Cl. CPC H04J 11/0036; H04J 11/0079; H04L 25/024

(57) ABSTRACT

Examples pertaining to cross-link-interference (CLI) mitigation in mobile communications are described. A user equipment (UE) receives a first signal in a reception band. The UE generates an estimated interference signal based on a model. The UE cancels CLI from a peer apparatus in the first signal by using the estimated interference signal. The model comprises a non-linear model which models at least one of non-linearity of a power amplifier and a crest factor reduction (CFR) operation.

### CROSS REFERENCE TO RELATED PATENT APPLICATION(S)

The present disclosure is part of a non-provisional application claiming the priority benefit of U.S. Patent Application No. 63/490,310, filed 15 Mar. 2023, the content of which herein being incorporated by reference in its entirety.

### TECHNICAL FIELD

The present disclosure is generally related to mobile communications and, more particularly, to cross-link-interference mitigation in mobile communications.

### BACKGROUND

Unless otherwise indicated herein, approaches described in this section are not prior art to the claims listed below and are not admitted as prior art by inclusion in this section.

In wireless communication environments, wireless signals transmitted or broadcast by nodes or apparatuses in a wireless network may cause cross-link-interference (CLI) to neighboring nodes or apparatuses in the neighboring areas. Moreover, in-band emission (IBE), which is defined as a ratio of the user equipment (UE) output power in a non-allocated resource block (RB) to the UE output power in an allocated RB, is also an unwanted interference in wireless communication environments.

The 5th Generation (5G), New Radio (NR) introduces more dynamic and flexible information exchange between nodes. Device collaboration may be one of the newly developed technologies using the information exchange between nodes to achieve transceiving capability augmentation. However, when the CLI occurs between cooperative devices, the CLI caused by an aggressor device may generate unwanted IBE to a victim device.

Accordingly, how to mitigate CLI in the wireless communication environments becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to CLI mitigation with respect to the communication apparatus (e.g., the UE) and the network apparatus (e.g., a network node or a base station (BS), such as a next generation Node B (gNB)) in mobile communications.

In one aspect, a method may involve an apparatus receiving a first signal in a reception band and generating an estimated interference signal based on a model. The method may further involve the apparatus canceling cross-link-interference from a peer apparatus in the first signal by using the estimated interference signal.

In one aspect, an apparatus may involve a transceiver which, during operation, wirelessly communicates with at least one network node. The apparatus may also involve a processor communicatively coupled to the transceiver such that, during operation, the processor performs following operations: receiving, via the transceiver, a first signal in a reception band, generating an estimated interference signal based on a model, and canceling cross-link-interference from a peer apparatus in the first signal by using the estimated interference signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a wireless communication environment having two types of cross-link-interference in accordance with implementations of the present disclosure.

FIG. 2 is a diagram depicting an example scenario of device collaboration with CLI mitigation in accordance with implementations of the present disclosure.

FIG. 3 is a diagram depicting an example scenario of linearly superposing RS onto the transmission in-band emission in accordance with implementations of the present disclosure.

FIG. 4 is a diagram depicting an example scenario of two options of inserting RS in accordance with implementations of the present disclosure.

FIG. 5 is a diagram depicting an example communication system having an example communication apparatus and an example network apparatus in accordance with an implementation of the present disclosure.

FIG. 6 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to cross-link-interference mitigation. According to the present disclosure, a number of possible solutions may be implemented separately or jointly. That is, although these possible solutions may be described below separately, two or more of these possible solutions may be implemented in one combination or another.

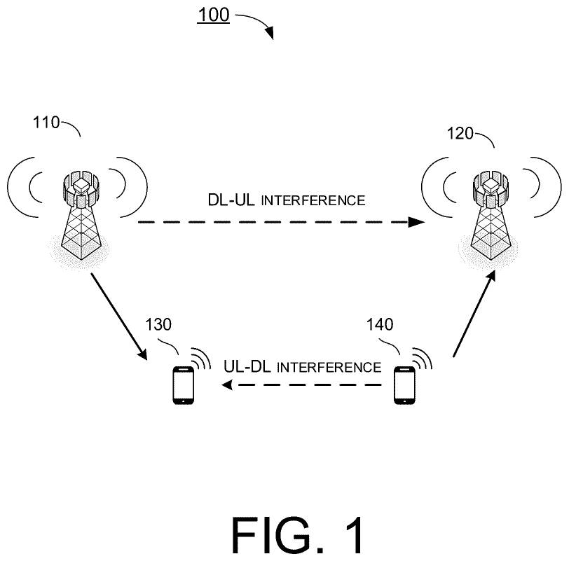

FIG. 1 illustrates an example scenario 100 of a wireless communication environment having two types of cross-link-interference in accordance with implementations of the present disclosure. The wireless communication environment may comprise at least two gNBs 110 and 120 and at least two UEs 130 and 140. The gNB 110 may transmit downlink (DL) signals to the UE 130 and the UE 140 may transmit uplink (UL) signals to the gNB 120.

When the transmission (Tx) and reception (Rx) operations between gNBs are performed concurrently or substantially concurrently, or are partially or fully overlapped in time, the gNB-to-gNB DL-UL interference (which is one type of CLI interference) may occur. The DL signals from the gNB 110 may interfere the UL signals from the UE 140. Similarly, when the Tx and Rx operations between UEs are performed concurrently or substantially concurrently, or are partially or fully overlapped in time, the UE-to-UE UL-DL interference (which is another type of CLI interference) may occur. The UL signals from the UE 140 may interfere the DL signals from the gNB 110.

In Release 18, 3rd Generation Partnership Project (3GPP) carried out a study on non-overlapping subband full-duplex (SBFD) at the gNB side. In non-overlapping SBFD networks (where the time-division duplexing (TDD) carrier is partitioned between UL and DL in certain symbols and slots), the in-band emission (Tx IBE) from the transmission may contaminate the reception subband or subcarriers and may constitute a source of interference.

In the discussion of the feasibility of full-duplex operation in a subsequent study phase, the SBFD supported at the UE side is expected. When the Tx IBE that contaminates the reception subband or subcarriers of an apparatus is originated from the transmission of the apparatus itself, the interference constituted by the Tx IBE is called self-interference or residual-self-interference.

Similarly, interference may occur between cooperative devices, where one UE relays the UL payload of another UE while the latter UE tries to receive DL signals. When the two UEs are physically close to each other, which creates strong UE-to-UE CLI. That is, the Tx IBE from the transmission of an aggressor UE (which is relaying in UL on behalf of another UE, named as a victim UE) may contaminate the reception of the victim UE, while transmission is actually originated from the victim UE.

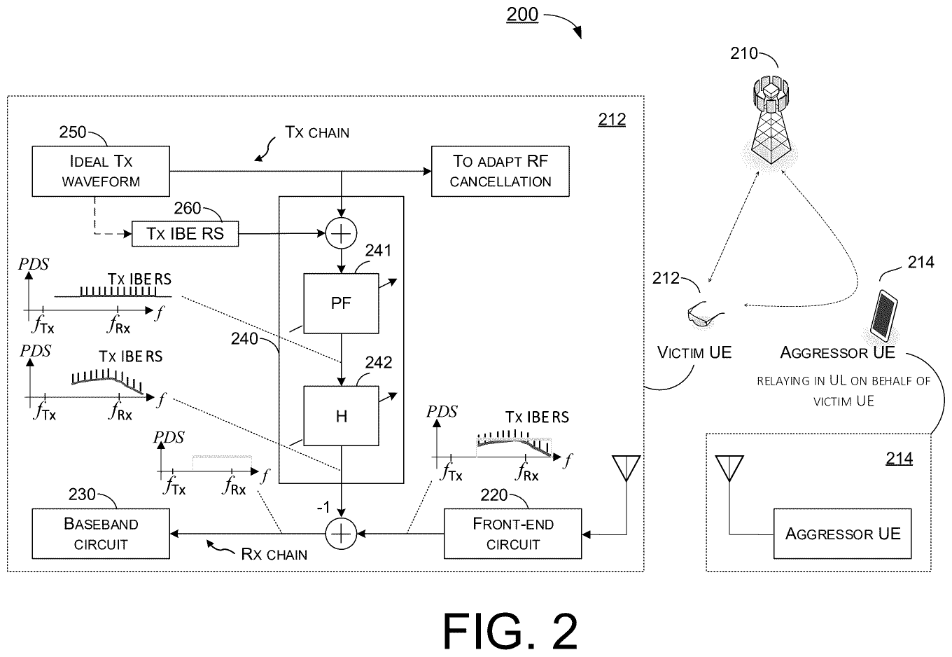

FIG. 2 illustrates an example scenario 200 of device collaboration with CLI mitigation in accordance with implementations of the present disclosure. A primary communication apparatus (e.g., a UE) 212 may communicate with a network node 210 and communicate with a collaborating communication apparatus (e.g., a UE) 214 as well. The collaborating communication apparatus 214, as a transmitter with stronger energy supply, may relay signals or data in UL direction to the network node 210 on behalf of primary communication apparatus 212, to augment transceiving capability of the primary communication apparatus 212. Therefore, in some implementations, the UL transmission of the collaborating communication apparatus 214 may contain payload relayed from the primary communication apparatus 212.

In this example, the primary communication apparatus 212 may suffer CLI from Tx IBE of the collaborating communication apparatus 214, that's why the primary communication apparatus 212 is denoted as victim UE and the collaborating communication apparatus 214 is denoted as aggressor UE in FIG. 2.

A simplified block diagram of the victim UE is also shown in FIG. 2. For the scenario when the aggressor UE performs UL transmission and the victim UE performs DL reception, the victim UE receives a DL signal (e.g., a first signal) in a reception band. The interference due to the transmission in the transmission band f_{Tx} comprised in the first signal may be eliminated, cancelled or removed by the front-end circuit 220 of the victim UE.

In some implementations, the front-end circuit 220 in the reception chain (RX chain) of the victim UE may comprise, for example but not limited to, a low noise amplifier (LNA), a mixer circuit for frequency down-conversion, an analog baseband circuit, an analog-to-digital converter (ADC) and/or a digital front-end circuit.

In some implementations, to mitigate CLI caused by Tx IBE of the aggressor UE, the victim UE may use at least a non-linear model of IBE generation. In some implementations, the Tx IBE may fall within the bandwidth of the concurrent or substantially concurrent DL reception of the victim UE.

In some implementations, the victim UE may comprise a model 240 to model the interference path. In some implementations, a channel estimation may be made between the Tx and Rx chains/circuits.

In some implementations, the victim UE may generate an estimated interference signal based on the model 240. In some implementations, the model 240 is utilized to simulate, estimate or generate the Tx IBE for a subsequent cancellation to cancel or mitigate unwanted Tx IBE in the DL signal (e.g., the first signal), where the unwanted Tx IBE is generated or induced by the relay operation of the aggressor UE.

In some implementations, the victim UE may cancel or mitigate the CLI caused by Tx IBE of the aggressor UE in the first signal by using the estimated interference signal, for example, by subtracting the estimated interference signal from the output of the front-end circuit 220 as shown in FIG. 2. The signal after the CLI cancellation may be further provided to the baseband circuit 230 for subsequent baseband signal processing.

In some implementations, the model 240 may comprise a non-linear model 241, which models at least one of non-linearity of a power amplifier of the aggressor UE and/or a crest factor reduction (CFR) operation performed by the aggressor UE, and a linear model 242, which models a channel of interference (e.g., a self-interference channel and/or a channel between the aggressor UE and the victim UE or between a transmitter and a receiver). In some implementations, the non-linear model 241 may be a polynomial fit (PF) and is denoted as PF in FIG. 2, and the linear model 242 is denoted as H in FIG. 2.

In some implementations, the non-linear model 241 may generate the Tx IBE based on the ideal Tx waveform 250. In some implementations, the ideal Tx waveform 250 may be a copy of the original Tx waveform to be transmitted, being transmitted or has been transmitted by the victim UE. In some implementations, the ideal Tx waveform 250 may be the original Tx waveform that has not been suffered from the interference.

As an example, in some implementations, the victim UE may transmit a UL signal (e.g., a second signal) in a transmission band and generate a transmission waveform (e.g., the ideal Tx waveform 250) based on the transmission payload. The transmission waveform may be provided as an input of the model to generate the estimated interference signal. In some implementations, the second signal may be transmitted to the aggressor UE for a relay operation.

In some implementations, the baseband circuit of the victim UE in the Tx chain may reproduce the ideal Tx waveform 250 of the aggressor UE based on knowledge of the Tx payload (since the aggressor UE's UL transmission contains payload relayed from the victim UE) and resource allocation, or based on reception if delay can be handled by buffering DL. In some implementations, the ideal Tx waveform 250 may be further provided to adapt RF cancellation.

In some implementations, a reference signal (RS), such as the Tx IBE RS 260, may be also provided to the input of the model to generate the estimated interference signal. In some implementations, the Tx IBE RS may depend from a transmission of the victim UE. For example, the pattern of the Tx IBE RS may be selected or designed based on the transmission of the victim UE, or may be generated based on the ideal Tx waveform 250. In one approach, the Tx IBE RS 260 may be selected/implemented as the demodulation reference signals (DMRS).

The power density spectrum (PDS) of the signals before and after CLI cancellation or mitigation are also shown in FIG. 2, to illustrate the non-linearity modeling and linear modeling of the model 240 and the operation of CLI cancellation or mitigation.

In some implementations, information regarding the non-linear model 241 and the linear model 242, such as the model parameters, may be identified separately, to improve the accuracy and convergence time. In some implementations, information regarding the non-linear model 241 and/or the linear model 242 may be identified on the fly or may come from some calibration or training procedure.

In some implementations, the information regarding the non-linear model 241 may be identified (e.g. by fitting a polynomial in frequency or time-domain) by the aggressor UE (i.e., the collaborating communication apparatus 214) and shared with the victim UE (i.e., the primary communication apparatus 212). The victim UE may receive or learn the information regarding the non-linear model 241 from the aggressor UE. That is, in some implementations, the information or the configuration of the model and/or the RS is shared between collaborative devices for CLI mitigation.

In some implementations, the non-linear model 241 may be determined or trained by the victim UE.

In some implementations, in an event that the non-linear model 241 models the CFR operation performed by the aggressor UE, the information regarding the non-linear model 241 (e.g., one or more parameters of the non-linear model 241) may be determined by the victim UE according to a CFR algorithm adopted by the aggressor UE. In some implementations, the CFR algorithm may be pre-stored or pre-configured in the victim UE and/or known by the victim UE.

Note that although the terms “aggressor UE” and “victim UE” are denoted in FIG. 2 and used in the above paragraphs to illustrated UE-to-UE CLI cancellation or mitigation, the present disclosure is actually not limited to the UEs and can be applied to gNBs, relays, intelligent reflective surfaces, etc. That is, for the implementations with respect to gNB-to-gNB CLI cancellation or mitigation, the terms “aggressor UE” (or transmitter) and “victim UE” (or receiver) may be replaced by the terms “aggressor gNB” and “victim gNB”. In addition, the model and associated signal processing for the CLI cancellation or mitigation as illustrated in FIG. 2 and introduced in the present disclosure may also be applied for gNB-to-gNB CLI cancellation or mitigation.

In some implementations, the RS may be added to the Tx waveform in frequency resource blocks where necessary for cancellation of Tx IBE from the reception.

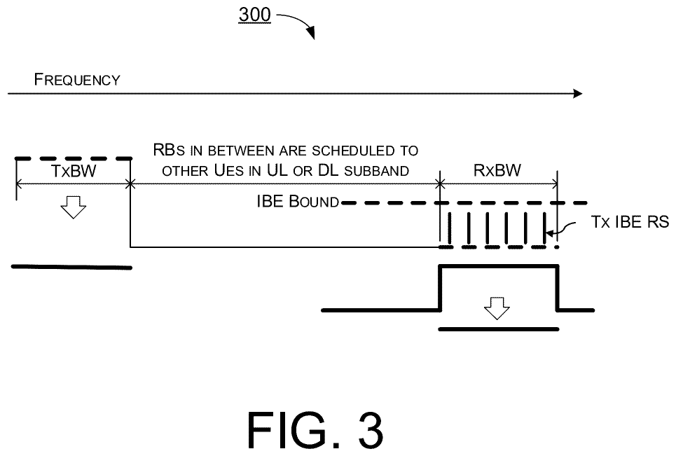

FIG. 3 illustrates an example scenario 300 of linearly superposing RS onto the transmission in-band emission in accordance with implementations of the present disclosure. As shown in FIG. 3, an apparatus (e.g., a UE or a gNB) may perform transmission (e.g., in a physical uplink shared channel (PUSCH) for the UE case) in the transmission bandwidth (TxBW) and may perform reception (e.g., in a physical downlink shared channel (PDSCH) for the UE case) in the reception bandwidth (RxBW). The resource blocks (RBs) in between the TxBW and the RxBW may be scheduled to other UEs in the UL or DL subband(s). The apparatus may linearly superpose or insert the RS (e.g., the Tx IBE RS) onto the Tx waveform to compensate for or to cancel unwanted interference. Note that the IBE bound is below the power density of the transmission in the TxBW. Also note that in some scenario, the unwanted Tx IBE may start higher at the TxBW and keep decreasing through the frequency bandwidth between the TxBW and the RxBW.

In some implementations, the Tx IBE RS may be added or inserted in frequency regions used by victim UEs or victim gNBs for assisting CLI cancellation or mitigation, as illustrated in FIG. 2 for the application in CLI cancellation. Note that for the application in self-interference, in some implementations, the Tx IBE RS may also be added for assisting self-interference compensation, cancellation or mitigation. That is, the apparatus (either the UE or the gNB) may add an RS to the Tx waveform in frequency resource blocks where necessary for cancellation of Tx IBE from the reception by the apparatus itself or by a victim apparatus.

In some implementations, the RS may assist in estimating the channel (e.g., a self-interference channel and/or a channel between the aggressor UE and the victim UE or between the aggressor gNB and the victim gNB). In some implementations, the RS may depend from a current transmission.

In some implementations, the apparatus (e.g., the victim UE or the victim gNB) may transmit the RS in at least one of the reception bands, or in a frequency band between the transmission band and the reception band. The apparatus may estimate the channel or identity the linear model 242 which models the channel based on the RS.

In some implementations, the RS (e.g., the Tx IBE RS) does not harm the Rx linearity and obeys the 3GPP Tx IBE bound. In some implementations, the RS may be limited to certain subcarriers (and certain symbols), or may have a different subcarrier spacing (SCS). In some implementations, the RS may have pre-configured or ad-hoc phases and/or magnitudes.

In some implementations, the RS may be added to the digital baseband Tx waveform or inserted before a frequency up-conversion. In some implementations, the RS may be added at a stage of performing orthogonal frequency division multiplexing (OFDM) signal generation.

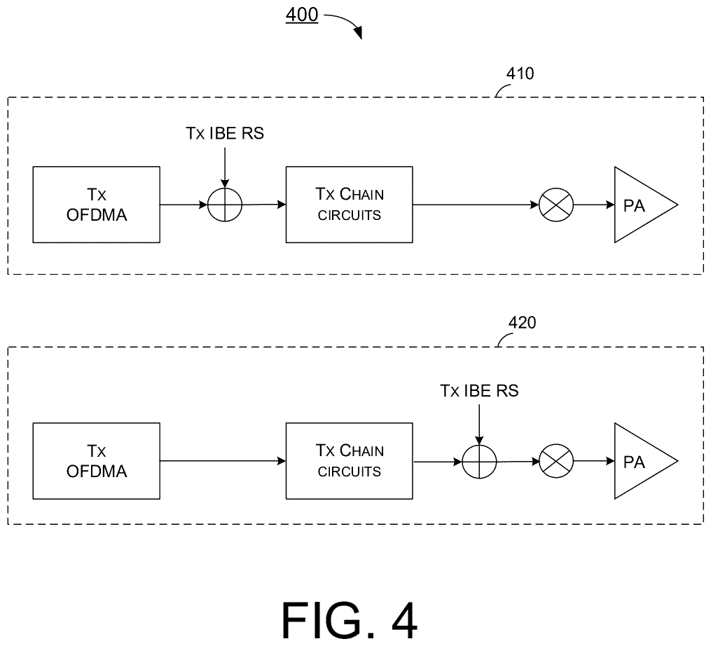

FIG. 4 illustrates an example scenario 400 of two options of inserting RS in accordance with implementations of the present disclosure. In some implementations, the OFDM signal generation may be performed by or after the Tx orthogonal frequency division multiple access (OFDMA) block shown in FIG. 4, and the Tx chain circuits may comprise one or more digital signal processing circuits and one or more analog signal processing circuits.

In the first option 410, the Tx IBE RS is added to the digital baseband Tx waveform. In the second option 420, the Tx IBE RS inserted before a frequency up-conversion and thus added to the input of a mixer circuit. Noted that the second option may be motivated by Tx noise filtering in Tx path.

In some implementations, the RS (e.g., the Tx IBE RS) may be transmitted in a stage of training or calibrating the model. In some implementations, the RS may be applied only during calibration or training stage. In some implementations, the RS may be only transmitted during the training phase which precedes a phase of actual information reception (such as a DL information reception of the UE).

### Illustrative Implementations

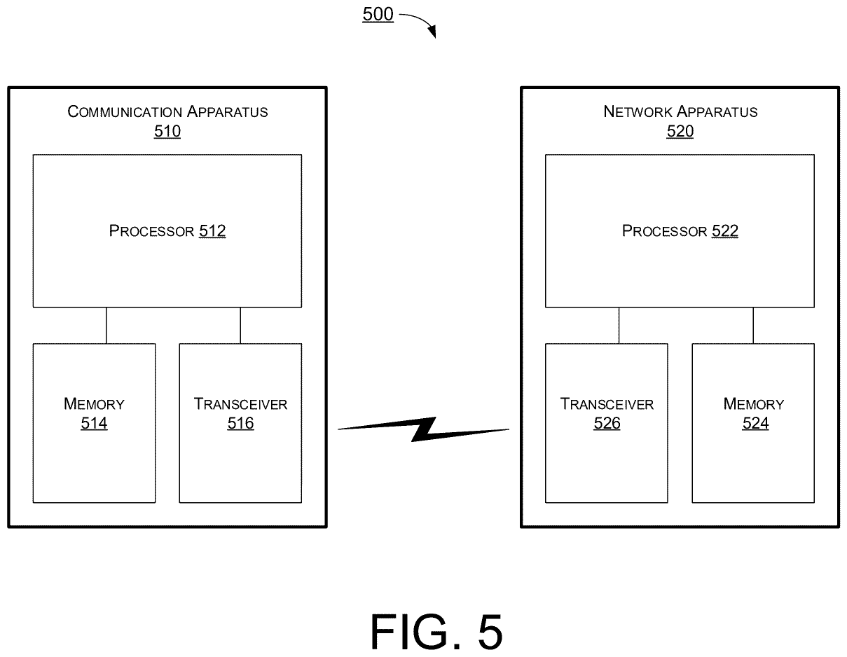

FIG. 5 illustrates an example communication system 500 having an example communication apparatus 510 and an example network apparatus 520 in accordance with an implementation of the present disclosure. Each of the communication apparatus 510 and the network apparatus 520 may perform various functions to implement schemes, techniques, processes and methods described herein pertaining to CLI mitigation in mobile communications, including scenarios/schemes described above as well as the process 600 described below.

The communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of a network device, which may be a network node such as a satellite, a base station, a small cell, a router or a gateway. For instance, the network apparatus 520 may be implemented in an eNodeB in an LTE network, in a gNB in a 5G/NR, IoT, NB-IoT or IIoT network or in a satellite or base station in a 6G network. Alternatively, the network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

In one aspect, each of the processor 512 and the processor 522 may be implemented in the form of one or more single-core processors, one or more multi-core processors, or one or more CISC processors. That is, even though a singular term “a processor” is used herein to refer to the processor 512 and the processor 522, each of the processor 512 and the processor 522 may include multiple processors in some implementations and a single processor in other implementations in accordance with the present disclosure. In another aspect, each of the processor 512 and the processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and the processor 522 is a special-purpose machine specifically designed, arranged and configured to perform specific tasks including autonomous reliability enhancements in a device (e.g., as represented by the communication apparatus 510) and a network (e.g., as represented by the network apparatus 520) in accordance with various implementations of the present disclosure.

In some implementations, the communication apparatus 510 may also include a transceiver 516 coupled to the processor 512 and capable of wirelessly transmitting and receiving data. In some implementations, the communication apparatus 510 may further include a memory 514 coupled to the processor 512 and capable of being accessed by the processor 512 and storing data therein. In some implementations, the network apparatus 520 may also include a transceiver 526 coupled to the processor 522 and capable of wirelessly transmitting and receiving data. In some implementations, the network apparatus 520 may have a plurality of physical antennas which associates with a plurality of antenna ports. In some implementations, the network apparatus 520 may further include a memory 524 coupled to processor 522 and capable of being accessed by the processor 522 and storing data therein. Accordingly, the communication apparatus 510 and the network apparatus 520 may wirelessly communicate with each other via the transceiver 516 and the transceiver 526, respectively. To aid better understanding, the following description of the operations, functionalities and capabilities of each of the communication apparatus 510 and the network apparatus 520 is provided in the context of a mobile communication environment in which the communication apparatus 510 is implemented in or as a communication apparatus or a UE and the network apparatus 520 is implemented in or as a network node or a network device of a communication network.

In some implementations, for the case of UE-to-UE CLI cancellation or mitigation, the apparatus performing the following operations is the communication apparatus 510 and the communication apparatus 510 may wirelessly communicate with another communication apparatus (e.g., a peer apparatus, such as the aforementioned collaborating communication apparatus). Alternatively, for the case of gNB-to-gNB CLI cancellation or mitigation, the apparatus performing the following operations is the network apparatus 520 and the peer apparatus may be another gNB.

In some implementations, the processor 512 of the communication apparatus 510 or the processor 522 of the communication apparatus 520 may receive a first signal in a reception band via the transceiver 516 or via the transceiver 526. The processor 512 or the processor 522 may generate an estimated interference signal based on a model and cancel cross-link-interference from a peer apparatus in the first signal by using the estimated interference signal.

In some implementations, the model may comprise a non-linear model which models at least one of non-linearity of a power amplifier and a CFR operation, and the processor 512 or the processor 522 may receive information regarding the non-linear model from the peer apparatus via the transceiver 516 or via the transceiver 526.

In some implementations, the model may comprise a non-linear model which models a CFR operation, and the processor 512 or the processor 522 may determine one or more parameters of the non-linear model according to a CFR algorithm.

In some implementations, the model may comprise a non-linear model which models at least one of non-linearity of a power amplifier and a CFR operation, and the processor 512 or the processor 522 may train or determine the non-linear model.

In some implementations, the processor 512 or the processor 522 may transmit a second signal comprising transmission payload in a transmission band via the transceiver 516 or via the transceiver 526 and generate a transmission waveform based on the transmission payload. In the generating of the estimated interference signal, the processor 512 or the processor 522 may provide the transmission waveform as an input of the model to generate the estimated interference signal.

In some implementations, the second signal may be transmitted to the peer apparatus, and the cross-link-interference may be induced by a relay operation of the peer apparatus which relays the second signal.

In some implementations, the model comprises a linear model which models a channel, and the processor 512 or the processor 522 may transmit a reference signal in at least one of the reception band or a frequency band between a transmission band and the reception band via the transceiver 516 or via the transceiver 526 and estimate the channel based on the reference signal.

In some implementations, the processor 512 or the processor 522 may insert the reference signal before performing a frequency up-conversion or at a stage of performing OFDM signal generation.

In some implementations, the reference signal may be transmitted in a stage of training or calibrating the model.

In some implementations, the peer apparatus may be a UE or a gNB, and the CLI may be a UE-to-UE CLI or a gNB-to-gNB CLI.

### Illustrative Processes

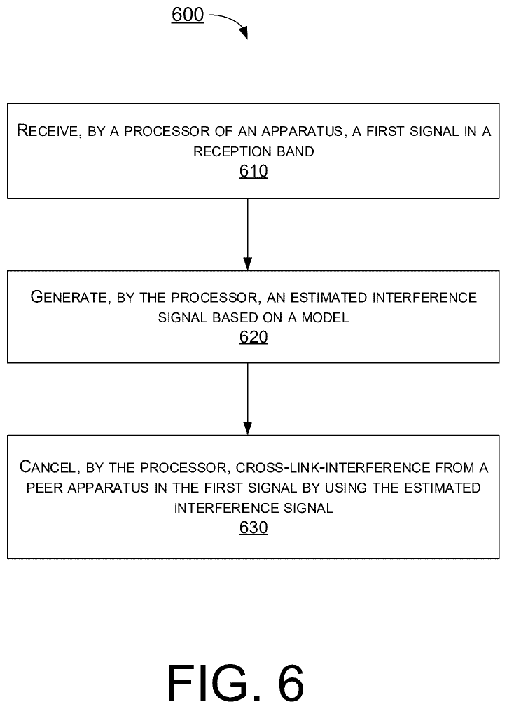

FIG. 6 illustrates an example process 600 in accordance with an implementation of the present disclosure. The process 600 may be an example implementation of above scenarios/schemes, whether partially or completely, with respect to CLI mitigation in mobile communications in accordance with the present disclosure. The process 600 may represent an aspect of implementation of features of the communication apparatus 510 or the network apparatus 520. The process 600 may include one or more operations, actions, or functions as illustrated by one or more of blocks 610, 620 and 630. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE or machine type devices or implemented by the network apparatus 520. Solely for illustrative purposes and without limitation, the process 600 is described below in the context of the communication apparatus 510 or the network apparatus 520. The process 600 may begin at block 610.

At 610, the process 600 may involve the processor 512 of the communication apparatus 510 or the processor 522 of the communication apparatus 520 receiving a first signal in a reception band. The process 600 may proceed from 610 to 620.

At 620, the process 600 may involve the processor 512 or the processor 522 generating an estimated interference signal based on a model. The process 600 may proceed from 620 to 630.

At 630, the process 600 may involve the processor 512 or the processor 522 canceling cross-link-interference from a peer apparatus in the first signal by using the estimated interference signal.

In some implementations, the model may comprise a non-linear model which models at least one of non-linearity of a power amplifier and a CFR operation, and the process 600 may further involve the processor 512 or the processor 522 receiving information regarding the non-linear model from the peer apparatus.

In some implementations, the model may comprise a non-linear model which models a CFR operation, and the process 600 may further involve the processor 512 or the processor 522 determining one or more parameters of the non-linear model according to a CFR algorithm.

In some implementations, the model may comprise a non-linear model which models at least one of non-linearity of a power amplifier and a CFR operation, and the process 600 may further involve the processor 512 or the processor 522 training or determining the non-linear model.

In some implementations, the process 600 may further involve the processor 512 or the processor 522 transmitting a second signal comprising transmission payload in a transmission band via the transceiver 516 or via the transceiver 526 and generating a transmission waveform based on the transmission payload. In the generating of the estimated interference signal, the process 600 may further involve the processor 512 or the processor 522 providing the transmission waveform as an input of the model to generate the estimated interference signal.

In some implementations, the second signal may be transmitted to the peer apparatus, and the cross-link-interference may be induced by a relay operation of the peer apparatus which relays the second signal.

In some implementations, the model comprises a linear model which models a channel, and the process 600 may further involve the processor 512 or the processor 522 transmitting a reference signal in at least one of the reception band or a frequency band between a transmission band and the reception band via the transceiver 516 or via the transceiver 526 and estimating the channel based on the reference signal.

In some implementations, the reference signal may be inserted before a frequency up-conversion or at a stage of performing OFDM signal generation.

In some implementations, the reference signal may be transmitted in a stage of training or calibrating the model.

In some implementations, the peer apparatus may be a UE or a gNB, and the CLI may be a UE-to-UE CLI or a gNB-to-gNB CLI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first signal in a reception band;
generating, by the processor, an estimated interference signal based on a model; and
canceling, by the processor, cross-link-interference from a peer apparatus in the first signal by using the estimated interference signal.

2. The method of claim 1, wherein the model comprises a non-linear model which models at least one of non-linearity of a power amplifier and a crest factor reduction (CFR) operation, and the method further comprises:
receiving, by the processor, information regarding the non-linear model from the peer apparatus.

3. The method of claim 1, wherein the model comprises a non-linear model which models a crest factor reduction (CFR) operation, and the method further comprises:
determining, by the processor, one or more parameters of the non-linear model according to a CFR algorithm.

4. The method of claim 1, wherein the model comprises a non-linear model which models at least one of non-linearity of a power amplifier and a crest factor reduction (CFR) operation, and the method further comprises:
training or determining, by the processor, the non-linear model.

5. The method of claim 1, further comprising:
transmitting, by the processor, a second signal comprising transmission payload in a transmission band; and
generating, by the processor, a transmission waveform based on the transmission payload, and
wherein the generating of the estimated interference signal further comprises:
providing, by the processor, the transmission waveform as an input of the model to generate the estimated interference signal.

6. The method of claim 5, wherein the second signal is transmitted to the peer apparatus, and wherein the cross-link-interference is induced by a relay operation of the peer apparatus which relays the second signal.

7. The method of claim 1, wherein the model comprises a linear model which models a channel, and the method further comprises:
transmitting, by the processor, a reference signal in at least one of the reception band or a frequency band between a transmission band and the reception band; and
estimating the channel based on the reference signal.

8. The method of claim 7, wherein the reference signal is inserted before a frequency up-conversion or at a stage of performing orthogonal frequency division multiplexing (OFDM) signal generation.

9. The method of claim 7, wherein the reference signal is transmitted in a stage of training or calibrating the model.

10. The method of claim 1, wherein the peer apparatus is a user equipment (UE) or a next generation Node B (gNB), and wherein the cross-link-interference is a UE-to-UE cross-link-interference or a gNB-to-gNB cross-link-interference.

11. An apparatus, comprising:
a transceiver which, during operation, wirelessly communicates with at least one network node; and
a processor communicatively coupled to the transceiver such that, during operation, the processor performs operations comprising:
receiving, via the transceiver, a first signal in a reception band;
generating an estimated interference signal based on a model; and
canceling cross-link-interference from a peer apparatus in the first signal by using the estimated interference signal.

12. The apparatus of claim 11, wherein the model comprises a non-linear model which models at least one of non-linearity of a power amplifier and a crest factor reduction (CFR) operation, and wherein during operation, the processor further performs operations comprising:
receiving, via the transceiver, information regarding the non-linear model from the peer apparatus.

13. The apparatus of claim 11, wherein the model comprises a non-linear model which models a crest factor reduction (CFR) operation, and wherein during operation, the processor further performs operations comprising:
determining one or more parameters of the non-linear model according to a CFR algorithm.

14. The apparatus of claim 11, wherein the model comprises a non-linear model which models at least one of non-linearity of a power amplifier and a crest factor reduction (CFR) operation, and wherein during operation, the processor further performs operations comprising:
training or determining the non-linear model.

15. The apparatus of claim 11, wherein during operation, the processor further performs operations comprising:
transmitting, via the transceiver, a second signal comprising transmission payload in a transmission band; and
generating a transmission waveform based on the transmission payload, and
wherein in the generating of the estimated interference signal, the processor further performs operations comprising:
providing the transmission waveform as an input of the model to generate the estimated interference signal.

16. The apparatus of claim 15, wherein the second signal is transmitted to the peer apparatus, and wherein the cross-link-interference is induced by a relay operation of the peer apparatus which relays the second signal.

17. The apparatus of claim 11, wherein the model comprises a linear model which models a channel, and wherein during operation, the processor further performs operations comprising:
transmitting, via the transceiver, a reference signal in at least one of the reception band or a frequency band between a transmission band and the reception band; and
estimating the channel based on the reference signal.

18. The apparatus of claim 17, wherein during operation, the processor further performs operations comprising:
inserting the reference signal before performing a frequency up-conversion or at a stage of performing orthogonal frequency division multiplexing (OFDM) signal generation.

19. The apparatus of claim 17, wherein the reference signal is transmitted in a stage of training or calibrating the model.

20. The apparatus of claim 11, wherein the peer apparatus is a user equipment (UE) or a next generation Node B (gNB), and wherein the cross-link-interference is a UE-to-UE cross-link-interference or a gNB-to-gNB cross-link-interference.
